(19) United States
(12) Patent Application Publication
(10) Pub. No.: US 2013/0021445 A1
(43) Pub. Date: Jan. 24, 2013

(54) Camera Projection Meshes

(71) Applicants: Alexandre Cossette-Pacheco, Lachine (CA); Guillaume Laforte, Brossard (CA); Christian Laforte, Montreal (CA)

(72) Inventors: Alexandre Cossette-Pacheco, Lachine (CA); Guillaume Laforte, Brossard (CA); Christian Laforte, Montreal (CA)

(21) Appl. No.: 13/639,029

(22) PCT Filed: Apr. 7, 2011
(86) PCT No.: PCT/CA2011/000374

§ 371 Date: Oct. 2, 2012

Related U.S. Application Data
(60) Provisional application No. 61/322,950, filed on Apr. 12, 2010.

(51) Int. Cl. H04N 13/02

(52) U.S. Cl. 348/46; 348/E13.074

(57) ABSTRACT

A 3D rendering method is proposed to increase the performance when projecting and compositing multiple images or video sequences from real-world cameras on top of a precise 3D model of the real world. Unlike previous methods that relied on shadow-mapping and that were limited in performance due to the need to re-render the complex scene multiple times per frame, the proposed method uses, for each camera, one Camera Projection Mesh (“CPM”) of fixed and limited complexity per camera. The CPM that surrounds each camera is effectively molded over the surrounding 3D world surfaces or areas visible from the video camera. Rendering and compositing of the CPMs may be entirely performed on the Graphic Processing Unit (“GPU”) using custom shaders for optimal performance. The method also enables improved view-shed analysis and fast visualization of the coverage of multiple cameras.

### CROSS-REFERENCE TO RELATED APPLICATIONS

The present patent application claims the benefits of priority of commonly assigned U.S. Provisional Patent Application No. 61/322,950, entitled “Camera Projection Meshes” and filed at the United States Patent and Trademark Office on Apr. 12, 2010; the content of which is incorporated herein by reference.

### FIELD OF THE INVENTION

The present invention generally relates to tridimensional (also referred to as “3D”) rendering and analysis, and more particularly to high-performance (e.g. real-time) rendering of real images and video sequences projected on a 3D model of a real scene, and to the analysis and visualization of areas visible from multiple view points.

### BACKGROUND OF THE INVENTION

It is often desirable for software applications that perform 3D rendering (e.g. games, simulations, and virtual reality) to project video textures on a 3D scene, for instance to simulate a video projector in a room. Another exemplary application consists in projecting video sequences from video cameras on a realistic 3D model of a room, building or terrain, to provide a more immersive experience in tele-conferencing, virtual reality and/or video surveillance applications. Combined with a 3D navigation system, this approach enables an operator to see novel views, e.g. a panorama consisting in a composite of multiple images or video sequences.

In the specific case of a 3D video surveillance application, this capability enables a security operator to monitor one or more video sequences from surveillance cameras in the context of a 3D model, providing better situational awareness. To provide the user with consistent information, the image must be correctly mapped to the appropriate 3D surfaces, have accurate placement and be updated in real-time.

Several basic approaches to video projection rendering have been described. For instance, Video Flashlight [“Video Flashlights—Real Time Rendering of Multiple Videos for Immersive Model Visualization”, H. S. Sawhney et al, Thirteenth Eurographics Workshop on Rendering (2002)] uses projective textures, shadow mapping and multi-pass rendering. For each video surveillance camera, the video image is bound as a texture and the full scene is rendered applying a depth test on a previously generated shadow map. This process may be repeated N times for N video surveillance cameras part of the scene.

A problem however arises for complex scenes, composed of a large number of polygons, having a complex object hierarchy or many videos. Repeating the rendering of the whole scene rapidly becomes excessively expensive and too slow for real-time use.

An improved approach consists in processing more than one video camera in one rendering pass. This can be achieved by binding multiple video camera images as textures and perform per-fragment tests to verify whether any of the video cameras cover the fragment. This approach is however more complex to develop than the previous one and has hardware limits on the number of video surveillance cameras that can be processed in a single rendering pass. In addition, it still requires rendering the full scene multiple times. Essentially, while this method linearly increases the vertex throughput and scene traversal performance, it does nothing to improve the pixel/fragment performance.

There is thus a need for a more efficient method of rendering the video images of a large number of video cameras in a 3D scene.

A set of related problems consists in analyzing and visualizing the locations visible from one or multiple viewpoints. For instance, when planning where to install telecommunication antennas in a city, it is desirable that all important buildings and streets have a direct line of sight from at least one telecommunication antenna. Another example problem consists in visualizing and interactively identifying the optimal locations of video surveillance cameras, to ensure a single or multiple coverage of key areas in a complex security-critical facility. In Geographics Information Systems (hereinafter “GIS”), this problem is commonly solved using Viewshed Analysis (hereinafter “VSA”) (http://en.wikipedia.org/wiki/Viewshed_Analysis). Unfortunately, published VSA algorithms only handle simple scenarios such as triangular terrains, so they do not generalize to arbitrarily complex 3D models, e.g. indoor 3D models, tunnels and so on. Furthermore, because they do not take advantage of modern features found in Graphical Processing Units (hereinafter “GPU” or “GPUs”), VSA algorithms cannot interactively process the large 3D models routinely used by engineering and GIS departments, especially those covering entire cities or produced using 3D scanners and LIDAR.

There is thus also a need for a more efficient method of analyzing and visualizing the areas covered by one or multiple view points.

### SUMMARY OF THE INVENTION

The proposed rendering method increases video projection rendering performance by restricting the rendered geometry to only the surfaces visible to a camera, using a Camera Projection Mesh (hereinafter “CPM”), which is essentially a dynamically-generated simplified mesh that “molds” around the area surrounding each camera. In a typical scene (e.g. large building or city), a CPM is many orders of magnitude less complex than the full scene in terms of number of vertices, triangles or pixels, and therefore many orders of magnitude faster to render than the full scene.

In accordance with the principles of the present invention, the method firstly renders the 3D scene from the point of view of each camera, outputting the fragments' 3D world positions instead of colors onto the framebuffer texture. This creates a position map, containing the farthest points visible for each pixel of the framebuffer, as seen from the camera position.

Then, a mesh is built by creating triangles between the world positions in the framebuffer texture. This effectively creates a mesh molded over the 3D world surfaces visible to the camera. This mesh is stored in a draw buffer that can be rendered using custom vertex and fragment shader programs.

This process is repeated for each camera part of the 3D scene. The mesh generation process is fast enough to run in real-time, e.g. when some of the cameras are translated by an operator during design or calibration, or are fixed on a moving vehicle or person.

Finally, the built meshes are rendered individually instead of the full scene, with the video image of the corresponding camera bound as a texture. As the meshes project what is recorded by the cameras, they are called Camera Projection Meshes or CPM in the present description.

These meshes have a complexity that can easily be adjusted by the implementation and that is typically much lower than rendering the full scene, resulting in significant reduction in vertex computational load. For cameras with a limited field-of-view (hereinafter “FOV”), the meshes only cover the area actually within the FOV of the camera, so no computational cost is incurred in other areas of the 3D scene resulting in significant reduction in fragment computational load as well.

Understandably, even though the disclosed method is generally described herein in the context of a 3D video surveillance application, it is to be noted that the method is also applicable to other applications that can benefit from a high-performance 3D projection technique, including line-of-sight analysis and visualization problems typically handled using viewshed analysis or raytracing.

Other and further objects and advantages of the present invention will be obvious upon an understanding of the illustrative embodiments about to be described or will be indicated in the appended claims, and various advantages not referred to herein will occur to one skilled in the art upon employment of the invention in practice. The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying figures in which:

FIG. 1 is an example of vertex and fragment shader programs for generating a position map.

FIG. 2 is an example of vertex and fragment shader programs for rendering a CPM.

FIG. 3 is an example of vertex and fragment shader programs for rendering the coverage of a Pan-Tilt-Zoom (hereinafter “PTZ”) video surveillance camera.

### DETAILED DESCRIPTION OF THE PREFERRED EMBODIMENT

Novel methods for rendering tridimensional (3D) areas or scenes based on video camera images and video sequences will be described hereinafter. Although the invention is described in terms of specific illustrative embodiments, it is to be understood that the embodiments described herein are by way of example only and that the scope of the invention is not intended to be limited thereby.

The creation and use of a Camera Projection Mesh (hereinafter “CPM”) has four main phases:

a. the position map creation phase;

b. the mesh draw buffer creation phase;

c. the mesh rendering phase; and

d. the mesh invalidation phase.

Position Map Creation Phase

First a position map is created from the point of view of the video camera. A position map is a texture that contains coordinates (x, y, z, w) components instead of color values (red, green, blue, alpha) in its color components. It is similar to a depth map which contains depth values instead of color values in the color components. The world position of fragments visible to the surveillance cameras are written to this position map.

The position map creation process is as follows:

a. A framebuffer object with color texture attachment is created for rendering the scene. This framebuffer object uses a floating point texture format as it is meant to store 3D world positions values which are non integer values that require high precision. A standard 8 bits per channel integer texture format would require scaling the values and severely limit the precision of the values beyond usability. Thus 32 bits floating point precision is used for each of the red, green, blue and alpha channels. A texture resolution of 64 by 64 for PTZ cameras and 256 by 256 for fixed cameras was found to yield precise results in practice. This resolution can be reduced to generate CPM that are less complex and faster to render, or increased so they better fit the surfaces they are molded after.

b. The floating point color texture is cleared to values of 0 for all channels. This will later allow checking whether a world position has been written to a given pixel of the texture. It will be the case when the alpha channel is non-zero.

c. The 3D rendering engine is set up for rendering the full scene on the framebuffer object created in step (a) and using the video camera's view matrix, i.e. manually or automatically calibrated position, orientation and field of view relative to 3D scene.

d. The full scene is rendered, using custom vertex and fragment shader programs in place of standard materials on the scene objects.

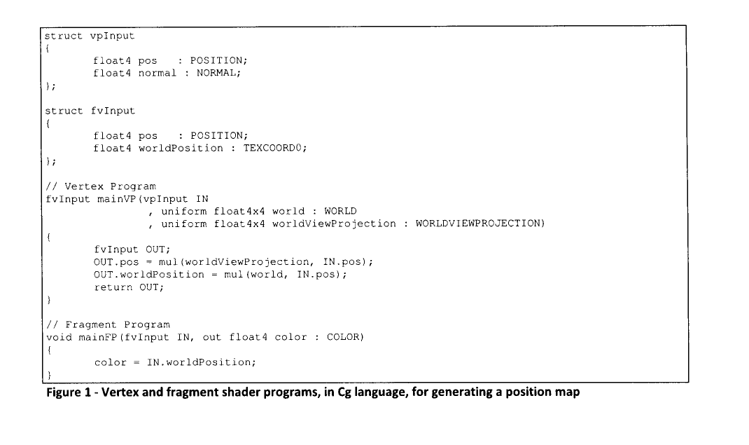

FIG. 1 presents an exemplary custom vertex shader suitable for this operation written in the Cg shader language. The main highlights of the vertex shader are:

i. The vertex program returns the vertex's homogenous clip space position as a standard passthrough vertex shader does, through the position semantic.

ii. The vertex program calculates and stores the vertex's world position and stores it in the first texture coordinate unit channel.

FIG. 1 also presents an exemplary custom fragment shader suitable for this operation written in the Cg shader language. The fragment program outputs the fragment's world position as the fragment shader color output. The fragment's world position is retrieved from the first texture coordinate unit channel and interpolated from the vertex world positions. This effectively writes the x, y and z components of the world position to the red, green and blue channels of the texture. The w component of the world position, which is always equal to one, is written to the alpha channel of the texture.

e. After this rendering, the texture contains the farthest world positions visible to the surveillance camera.

It is to be noted that most traditional 3D rendering optimizations still apply during the generation of position maps. For instance, this phase may be optimized by rendering a subset of the scene near the camera (as opposed to the entire scene), e.g. using coarse techniques like octrees, partitions and bounding boxes.

Mesh Draw Buffer Creation Phase

To create a mesh out of the position map, individual pixels are accessed to create a vertex with position corresponding to the world position that was written to the pixel. Triangles are created between adjacent vertices.

The mesh creation process is as follows:

a. The position map floating point texture data is copied to system memory. It is to be noted that as graphics hardware continues to evolve, this step is expected to soon be replaced by the use of geometry shaders or other fully GPU-based operations to further increase performance.

b. A new draw buffer is created. The draw buffer comprises a vertex buffer and an index buffer with the following properties:

i. The vertex buffer has storage for one vertex per pixel present on the position map floating point texture. Thus a 64 by 64 pixels floating point texture requires a vertex buffer with 4096 vertex entries. The format of a vertex entry is the following: 12 bytes for the vertex position, 12 bytes for the vertex normal and 8 bytes for a single two channel texture coordinate value.

ii. The index buffer has storage for creating two triangles for each group of 4 adjacent vertices/pixels (in a 2 by 2 grid pattern). Thus, it requires ((texture width−1)*(texture height−1)*6) index entries. A 64 by 64 floating point textures requires 63*63*6=11907 index entries.

c. A status buffer is created. This buffer is a simple array of Boolean values that indicates whether a given vertex of the vertex buffer is valid. It has the same number of entries as the vertex buffer has vertex entries.

d. An empty axis aligned bounding box is created. This bounding box will be expanded to include all vertices as they are created. This bounding box can be used in intersection tests to determine if the CPM is within the view frustum and should be rendered. Naturally, other types of bounding volumes could be used as well, e.g. bounding spheres.

e. Vertices are created for each of the pixel presents on the position map floating point texture. This operation is done as follows:

i. For each pixel of the position map, a new vertex entry is added to the vertex buffer of the draw buffer.

ii. The vertex position data of the vertex entry is set as read from the floating point texture data. This effectively sets the world position of the vertex to the world position present on the position map.

iii. If the floating point texture data's alpha channel value is 0, then the vertex is marked as invalid in the status buffer, otherwise it is marked as valid. Such a value of zero for the alpha channel of the floating point texture is only possible when no world position data has been written for the pixel. This happens when there is no 3D geometry present on such pixels.

iv. The texture coordinate data of the vertex entry is set as the current pixel's relative x and y position on the position map floating point texture. This effectively sets the texture coordinate to the relative position of the vertex in screen space when looking at the scene through the video surveillance camera. The vertex/pixel at position (x, y)=(0, 0) on the floating point texture has a texture coordinate value of (0, 0) while the vertex/pixel at position (63, 63) of a 64×64 texture has a texture coordinate value of (1, 1). This texture coordinate value can be used to directly map the video image of the video surveillance camera on the mesh.

v. If the vertex is marked as valid in the status buffer, its position is included in the bounding box.

f. Triangles are created by filling the index buffer with the appropriate vertex indices, with either zero or two triangles for each block of two by two adjacent vertices in a grid pattern. This operation is done as follows:

i. For each group of 2 by 2 adjacent vertices in a grid pattern where all four vertices are marked as valid in the status buffer, two triangles are created. The first triangle uses vertices 1, 2 and 3 while the second triangle uses vertices 2, 3 and 4. Both triangles will go through the triangle preservation test. If either triangle fail the triangle preservation test, both will be discarded and nothing will be appended to the index buffer for this group of vertices. This test uses heuristics to attempt eliminating triangles that are not part of world surfaces.

ii. For each of the two triangles, three edges are created between the vertices.

iii. A vertex normal is calculated for the triangle vertices by taking the cross product of two of these three edges. The vertex normal is stored in the vertex buffer for each of the vertices. It is to be noted that the normal of some of these vertices may be overwritten as another group of adjacent vertices is processed. But this has no significant impact on this implementation and it would be possible to blend normals for vertices that are shared between more than one group of adjacent vertices.

iv. The triangle's three inner angles are calculated from the edges.

v. The triangle pass the preservation test if all three inner angles are equal or greater than two degrees or if all three angles are equal or greater than one degree and the normal is mostly perpendicular to the floor. These heuristics have been found to give good results with many indoor and outdoor scenes.

vi. If both triangles pass the preservation test, they are kept and six index entries are appended to the index buffer, effectively appending the two triangles. It is to be noted that triangles that fail this preservation test are almost always triangles that do not have equivalent surfaces in the 3D scene. They are the result of aliasing, i.e.

when a far-away occluder is right next to an occluder close to the camera; they are initially connected because the CPM process does not take scene topology in consideration. Without this preservation test, these triangles which appear as thin slivers pointing almost directly toward the center of the camera would cause significant visual defects during final rendering.

g. When all blocks of adjacent vertices have been processed, the index buffer is truncated to the number of index entries that were effectively appended.

h. A vertex position bias is finally applied on all vertex data. All vertices are displaced 1 cm in the direction of their normal in order to help solving depth fighting issues when rendering the mesh and simplify intersection tests. The 1 cm displacement was found to produce no significant artefact in indoor scenes and medium-sized outdoor scenes, e.g. 1 square km university campus. It may be selectively increased for much larger scenes, e.g. entire cities. It is preferable for the base unit to be expressed in meters, and for the models to be specified with a precise geo-referenced transform to enable precise compositing of large-scale environments (e.g. cities) from individual objects (e.g. buildings).

i. The draw buffer now contains a mesh that is ready to render on top of the scene.

Mesh Rendering Phase

The camera projection mesh rendering process is as follow:

a. Prior to rendering the CPM, the scene is rendered normally, i.e. with depth writes enabled, and objects (e.g. buildings, walls) drawn with solid colors or default textures.

b. The video image of the corresponding video surveillance camera is bound to a texture sampler.

c. Depth writes are disabled; rendering the video camera mesh should not change the depth of visible fragments in the frame buffer. The vertex displacement that was applied to the mesh's vertices would have the undesired side-effect of slightly changing these depths for fragments covered by the mesh.

d. The draw buffer is rendered using custom vertex and fragment shader programs.

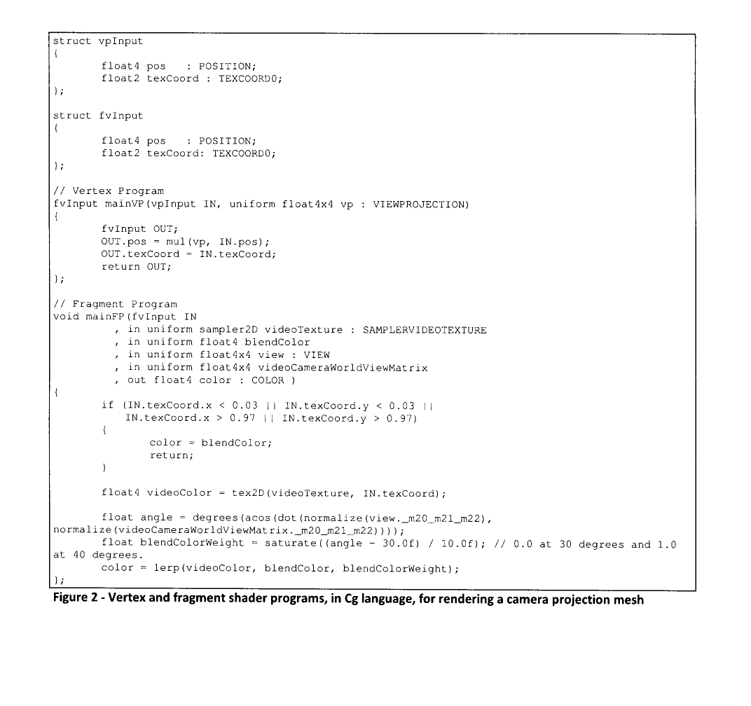

FIG. 2 presents an exemplary custom vertex shader suitable for this rendering operation. The main highlights of this vertex shader are:

i. The vertex program returns the vertex's homogenous clip space position as a standard passthrough vertex shader does, through the position semantic.

ii. The vertex program passes the vertex texture coordinate through in the first texture coordinate channel.

FIG. 2 also presents an exemplary custom fragment shader suitable for this rendering operation. The main highlights of this fragment shader are:

i. The shader takes in the view matrix of the video camera whose mesh is being rendered as a uniform parameter.

ii. The shader takes in the view matrix of the current camera whose point of view is being rendered from as a uniform parameter.

iii. The shader takes in a color value, named the blend color, as a uniform parameter. This color may be used to paint a small border around the video image. It may also be used in place of the video image if the angle between the video camera and the current rendering camera is too large and displaying the video image would result in a severely distorted image. This is an optional feature.

iv. First, the shader may verify whether the fragment's texture coordinate is within 3% distance in video camera screen space of the video image border. If so, it returns the blend color as the fragment color and stops further processing. This provides an optional colored border around the video image. It is to be noted that the default 3% distance is arbitrary and chosen for aesthetic reason. Other values could be used.

v. Otherwise, the shader samples the video image color from the texture sampler corresponding to the video image at the texture coordinate received in the first texture coordinate channel.

vi. The shader calculates the angle between the video camera's view direction and the rendering camera's view direction.

vii. If the angle is below 30 degrees, then the shader returns the video image color for the fragment. If the angle is between 30 and 40 degrees, then it gradually blends between the video image color and the blend color. Above 40 degrees, the blend color is returned for the fragment color.

Mesh Invalidation Phase

Whenever the video camera changes position, orientation or zoom value, the mesh should be discarded and regenerated anew to ensure that the video image matches the 3D geometry it is has been created from. The same should be done if the 3D model geometry changes within the video camera view frustum.

Rendering the Coverage of a PTZ Camera

The camera projection meshes idea can be used to render the coverage area of a PTZ video surveillance camera, or more generally, any omnidirectional sensor: radio antenna, panoramic cameras, etc.

This operation is realized as follows:

a. Create multiple (e.g. six) position maps to generate multiple (e.g. 6) meshes using the process described earlier as to support a wider field of view, e.g. using a cubic environment map. In the cubic environment map approach, each of the six cameras is positioned at the PTZ video camera's position and oriented at 90 degrees of each other to cover a different face of a virtual cube built around the position. Each camera is assigned a horizontal and vertical field of views of 90 degrees. In the Omnipresence 3D software, slightly larger fields of view of 90.45 degrees are used in order to eliminate visible seams that appear at edges of the cube. (This angle was selected so that, at a resolution of 64×64, the seams are invisible, i.e. the overlap is greater than half a texel.)

b. After each draw buffer is prepared, an extra processing step is performed on the vertex and index buffers to remove triangles that lie outside the camera's PTZ range.

i. For each triangle in the index buffer (each group of three vertices), the pan and tilt values of each vertex relative to the camera zero pan and tilt are calculated. They are calculated by transforming the vertex world position in the PTZ video camera's view space and applying trigonometry operations. The pan value is obtained by calculating the arctangent value of the x and z viewspace position values. The tilt value is obtained from the arccosine of the y viewspace position value divided by the viewspace distance.

ii. The pan and tilt values are stored in the texture coordinate channel of the vertex data. The texture coordinate value previously stored is thus discarded, as it will not be needed for rendering the meshes.

iii. If any of the three vertices is within the camera's pan and tilt ranges, the triangle is kept. Else, the three vertices are discarded from the index buffer.

c. The coverage of the PTZ camera can then be rendered by rendering the six generated draw buffers using custom vertex and fragment shader programs.

d. The vertex program is the same as for rendering the video camera projection meshes.

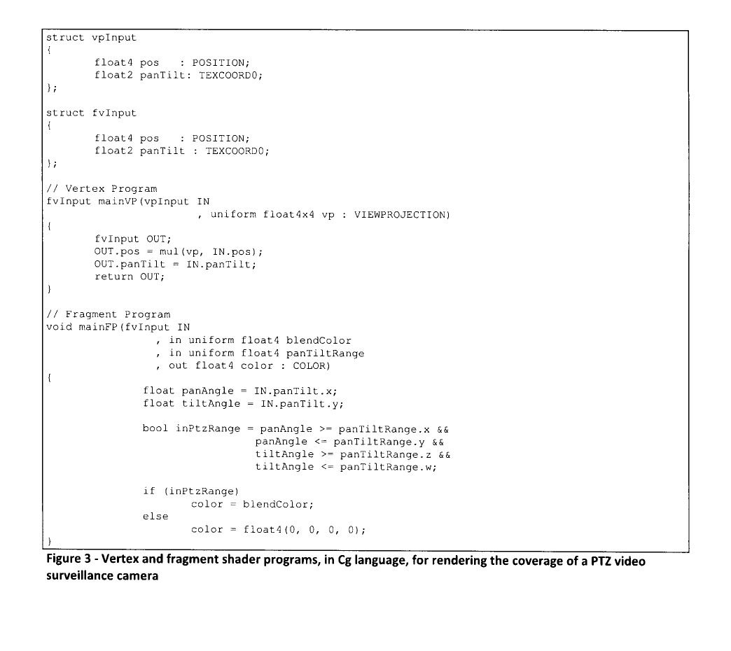

FIG. 3 presents an exemplary custom fragment shader program suitable for this operation. The highlights of this fragment shader are:

i. The shader takes in the pan and tilt ranges of the PTZ video camera as a uniform parameter.

ii. The shader takes in a color value, named the blend color, as a uniform parameter. This color will be returned for whichever fragment are within the PTZ coverage area.

iii. The shader verifies if the fragment's pan and tilt position values, as received in the first texture coordinate channel, are within the pan and tilt range. If it is the case, then it returns the blend color, else it returns transparent black color (red, green, blue, alpha)=(0, 0, 0, 0).

Other Optional Features

Panoramic lenses: The support for PTZ camera can be slightly modified to support panoramic lenses (e.g. fish-eye or Panomorph lenses by Immervision) as well, by generating the CPM assuming a much larger effective field of view to a much larger value, e.g. 180 degrees×180 degrees for an Immervision Panomorph lens. It is to be noted that the CPM mesh may use an irregular mesh topology, instead of the default regular grid array or box of grids (for PTZ). For instance, for a panoramic lens, the mesh points may be tighter in areas where the lens offers more physical resolution, e.g. around the center for a fish-eye lens.

Addressing aliasing artefacts: One down-side of using a regular grid is that, in extreme cases (e.g. virtual camera very close to the CPM, combinations of occluders that are very far and very close to a specific camera), aliasing artefacts may become noticeable, e.g. triangles that don't follow precisely the underlying scene geometry resulting in jagged edges on the border of large polygons. In practice, these problems are almost always eliminated by increasing the resolution of the CPM mesh, at a cost in performance. An optional, advanced variation on the present embodiment that address the aliasing problem is presented next.

High-resolution grid followed by simplification: Instead of generating a CPM using a regular grid, an optimized mesh may be generated. The simplest way consists in generating a higher-resolution grid, then running a triangle decimation algorithm to collapse triangles that are very close to co-planar. This practically eliminates any rare aliasing issues that remain, at a higher cost during generation.

Visible Triangle Subset: Another possible way to perform a 3D rendering of the coverage or 3D video projection, involves identifying the subset of the scene that is visible from each camera. Instead of the Position map creation phase, the framebuffer and rendering pipeline is configured to store triangle identifiers that are unique across potentially multiple instances of the same 3D objects. This can be recorded as pairs of {object ID, triangle ID}, e.g. using 24 bits each. These IDs can be generated on the fly during scene rendering, so object instances are properly taken in consideration, e.g. by incrementing counters during traversal. Doing this during traversal helps keep the IDs within reasonable limits (e.g. 24 bits) even when there are a lot of object instances, especially when frustum culling and occlusion culling is leveraged during traversal. This may be repeated (e.g. up to 6 times to cover all faces of a cube) to support FOVs larger than 180 degrees. Once the object IDs and polygon IDs are generated for each pixel, the framebuffer is read in system memory, and the Visible Triangle Subset of {object ID, triangle ID} is compiled. The CPM can then be generated by generating a mesh that consists only of the Visible Triangle Subset, where each triangle is first clipped (e.g. in projective space) by the list of nearby triangles. This can be combined during final 3D render with a texture matrix transformation to project an image or video on the CPM, or to constrain the coverage to specific angles (e.g. the FOV of a fixed camera). This approach solves some aliasing issues and may, depending on the original scene complexity, lead to higher performance.

Infinitely-far objects: Instead of clearing the w component to 0 to indicate empty parts (i.e. no 3D geometry present on such pixel), the default value can be set to −1, and objects that are infinitely far (e.g. sky sphere) can be drawn with a w value of 0 so that projective mathematics (i.e. homogeneous coordinates) applies as expected. Negative w coordinates are then treated as empty parts. Using this approach combined with a sky sphere or sky cube, videos are automatically projected onto the infinitely far surfaces, so the sky and sun are projected and composited as expected.

CPU vs GPU: It is to be noted that mentions of where computations are performed (i.e. CPU or GPU), where data is stored (system memory vs video memory) and the exact order of the steps are only suggestions, and that a multitude of variations are naturally possible; the present invention is therefore not limited to the present embodiment. The present embodiment assumes a programmable GPU with floating-point framebuffer, and support for the Cg language (e.g. DirectX 9.x or OpenGL 2.x), but it could be adapted for less flexible devices as well (e.g. doing more operations in CPU/system memory), and to newer devices using different programming languages.

Overlapping Camera Projection Meshes: When two or more CPM overlap on screen, a scoring algorithm can be applied for each fragment, to determine which CPM will be visible for a given framebuffer fragment. (Note that this method is described with the OpenGL terminology, where there is a slight distinction between fragments and pixels. In other 3D libraries (e.g. DirectX) the term fragment may be replaced by sample, or simply combined with the term pixel.) The simplest approach is to score and sort the CPMs in descending order of the angle between the CPM camera view direction and the rendering camera view direction. Rendering the CPM sequentially in this sorted order will make the CPM whose view angle is the best for the rendering camera appear on top of the others.

A more elaborate approach may consist in a complex per-fragment selection of which CPM is displayed on top, taking into account parameters such as the camera resolution, distance and view angle to give each CPM a score for each fragment. In this approach, the CPM is rendered in arbitrary order and the CPM's per-fragment score is calculated in the fragment shader, qualifying how well the associated camera sees the fragment. The score is compared with the previous highest score stored in the framebuffer alpha channel. When the score is higher, the CPM's fragment color replaces the existing framebuffer color and the new score is stored in the framebuffer alpha channel. Otherwise, the existing framebuffer color and alpha channel is kept unmodified. This approach allows a distant camera with a slightly less optimal view angle but with much better video resolution to override the color of a closer camera with better view angle but significantly inferior video resolution. In addition, it allows a CPM that is projected on two or more different surfaces with different depths to only appear on the surfaces where the video quality is optimal while other CPMs cover the other surfaces.

Rendering visible areas for a camera or sensor: Instead of displaying video or images projected on the 3D model, it is often desirable to simply display the area covered by the camera (or other sensor like a radio emitter or radar) in a specific shade. This can easily be performed using the previously described method, by simply using a constant color instead of an image or video frame. This can be extended in two ways:

Rendering of coverage area using framebuffer blending: Blending can be enabled (e.g. additive mode) to produce “heat maps” of areas visible, e.g. so that areas covered by more cameras or sensor are displayed brighter.

Rendering of coverage area using render-to-texture or multiple passes: For each pixel in the framebuffer, a count of the number of cameras or sensors for which that pixel is visible can be kept temporarily, e.g. in an alpha texture or framebuffer stencil. This can then be read back and used as to compute (or look-up in a color mapping function or texture) a final color, e.g. so that areas covered by one camera are displayed in green, areas with two cameras in yellow, and areas with three or more cameras are displayed in red.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A method for performing a tridimensional rendering of a tridimensional area visible from a sensor onto an image comprising a plurality of pixels, the method comprising:
a) generating a position map containing a plurality of points visible from the sensor in a plurality of directions;
b) generating a projection mesh from the position map;
c) rendering the projection mesh onto the image.

2) The method as claimed in claim 1, wherein the plurality of points comprises the farthest points visible from the sensor in a plurality of directions.

3) The method as claimed in claim 1, wherein the sensor is a camera.

4) The method as claimed in claim 3, wherein the step of rendering the projection mesh comprises binding an image captured by the camera as a texture such as to perform a tridimensional texture projection.

5) The method as claimed in claim 4, wherein the image is a video frame captured by the camera.

6) The method as claimed in claim 1, wherein the step of generating the position map comprises using a framebuffer to render the tridimensional area from the point of view of the sensor and recording the tridimensional position of each of the pixels in the framebuffer.

7) The method claimed in claim 1, wherein the steps of generating a position map and rendering the projection mesh are performed using a graphics processing unit (GPU).

8) The method claimed in claim 1, wherein the step of generating a projection mesh comprises creating triangles linking points in the position map.

9) The method claimed in claim 1, wherein steps a) to c) are repeated for each of a plurality of sensors, whereby all tridimensional areas visible from the plurality of sensors are displayed substantially simultaneously.

10) The method claimed in claim 1, further comprising simplifying the generated mesh.

11) The method claimed in claim 1, wherein steps a) to c) are repeated for each of a plurality of sensors, and wherein the rendering step comprises scoring the generated projection meshes to determine the order in which the generated projection meshes will be displayed based on at least one criterion.

12) The method claimed in claim 11, wherein the at least one criterion is a closest view angle.

13) The method claimed in claim 11, wherein the step of scoring is performed for each of the pixels.

14) The method claimed in claim 1, wherein steps a) to c) are repeated for each of a plurality of sensors, and wherein the rendering step comprises determining a count, for each of the pixels, corresponding to the number of the plurality of sensors to which the pixel is visible.

15) The method claimed in claim 14, wherein for each of the pixels, the count is mapped into a color for display.

16) A method for performing a tridimensional rendering of a tridimensional area visible from a sensor onto an image comprising a plurality of pixels, the method comprising:
a) generating a list of triangles that are at least partially visible from the sensor;
b) clipping each of the partially visible triangles against adjacent partially visible triangles to produce a list of clipped triangles;
c) generating a projection mesh by concatenating the clipped triangles;
d) rendering the projection mesh onto the image.

17) The method as claimed in claim 16, wherein the sensor is a camera.

18) The method as claimed in claim 17, wherein the step of rendering the projection mesh comprises binding an image captured by the camera as a texture such as to perform a tridimensional texture projection.

19) The method as claimed in claim 17, wherein the image is a video frame captured by the camera.

20) The method as claimed in claim 16, wherein the step of generating the list of partially visible triangles comprises using a framebuffer to render the tridimensional area from the point of view of the sensor and recording a triangle ID for each of the pixels in the framebuffer.

21) The method as claimed in claim 16, wherein the step of generating a projection mesh comprises compiling the list of clipped triangles into the projection mesh.

22) The method as claimed in claim 16, wherein steps a) to d) are repeated for each of a plurality of sensors, whereby all tridimensional areas visible from the plurality of sensors are displayed substantially simultaneously.

23) The method as claimed in claim 16, wherein steps a) to d) are repeated for each of a plurality of sensors, and wherein the rendering step comprises scoring the generated projection meshes to determine the order in which the generated projection meshes will be displayed based on at least one criterion.

24) The method as claimed in claim 23, wherein the at least one criterion is a closest view angle.

25) The method as claimed in claim 23, wherein the step of scoring is performed for each of the pixels.

26) The method as claimed in claim 16, wherein steps a) to d) are repeated for each of a plurality of sensors, and wherein the rendering step comprises determining a count, for each of the pixels, corresponding to the number of the plurality of sensors to which the pixel is visible.

27) The method as claimed in claim 26, wherein for each of the pixels, the count is mapped into a color for display.

28) A computer-readable medium having stored therein instructions for performing a method according to claim 1.

29) A computer system having stored therein instructions for performing a method according to claim 1.
